(19) United States
(12) Patent Application Publication
(10) Pub. No.: US 2010/0225594 A1
(43) Pub. Date: Sep. 9, 2010

(54) Video frame recorder

(76) Inventors: Hipolito Saenz, Pasadena, TX (US); Virginia Saenz, Pasadena, TX (US)

Correspondence Address: LAW OFFICE OF DAVID MCEWING, P.O. BOX 70410, HOUSTON, TX, 77270, US

(21) Appl. No.: 12/380,913

(22) Filed: Mar. 5, 2009

Related U.S. Application Data
(63) Continuation of application No. 12/231,427, filed on Jan. 5, 2009.

(51) Int. Cl. G06F 3/041

(52) U.S. Cl. 345/173

(57) ABSTRACT

The invention comprises a video framed electronic frame display screen with a touch screen LCD, a power supply, a microprocessor, a memory component, video and audio input and output jacks adaptable to DVD and VCR players, cameras and mp3 players, and speakers. The video frame can contain a camera. The video frame display screen can be controlled by operation of the touch screen display or by a remotely operated infrared controller. The video frame display screen can also be controlled by a mouse and keyboard connected to the video frame.

### RELATED APPLICATION

This application claims priority to and the benefit of the entitled Video Frame Recorder, Ser. No. 12/231,427 filed Sep. 4, 2008.

### BACKGROUND OF INVENTION

1. Field of Use

The invention may be used for purposes including a decorative frame surrounding an electronic display screen for still photos or video clips. Visual display can be accompanied by an audio component. The audio component can be a radio or satellite radio. The invention can also perform editing of photos and videos. The photos and videos, including audio (if any) can be downloaded to an internal or external memory. Audio can be added and synchronized with specific photos or videos.

2. Related Technology

Electronic picture viewing apparatus for displaying electronic images in a picture frame type setting are known.

### SUMMARY OF INVENTION

The invention comprises an video frame electronic display screen with speakers, a touch screen LCD, a power supply (either DC battery or through an AC power cord), a microprocessor, a memory component comprising preferably 10 gigabytes of memory, video and audio input and output jacks or USB plugs adaptable to DVD and VCR players, cameras, phones and mp3 players, and an interface circuit connecting the microprocessor to a memory source (external or internal) and to the ports connectable to input/output jack and USB plugs. The interface circuit may connect to other peripheral or external components. The video frame display screen can be controlled via the touch display screen or by a remotely operated infra-red controller. It may also be controlled by a key board or mouse that plug into the video frame. The touch screen can alternatively be programmed to display an operative keyboard or mouse.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 is a front view of the video frame component surrounding the video screen with the microphone port, camera and the infra-red signal receiving port.

FIG. 2 is a side view of the video frame.

FIG. 3 is a perspective view of the video frame.

FIG. 4 is a perspective view of the interior of the video frame back panel showing the wall mounting component and ports for peripheral or external components located on the side.

FIG. 5 is a cross sectional view of the device showing the remote control device stored on the back and also a wall mounting component located on the back.

FIG. 6 is a cross sectional view of the port for the infra-red signal detector and corresponding to the arrows marked 6 in FIG. 1.

FIG. 7 is a cross sectional view of the video frame corresponding to the arrows marked 7 in FIG. 1.

FIG. 8 is exterior perspective drawing of the back cover of the video frame.

FIG. 9 is view of the back cover of the video frame.

FIG. 10 is a side view of the video frame.

FIG. 11 is a perspective view of the back of the video frame illustrating a stand component that can hold the video frame upright on a flat surface.

FIG. 12 is a perspective view of a remote control that may be used with the video frame.

FIG. 13 is an exploded view of the video frame including the front frame cover, the LCD screen, the PCB memory component, back cover and stand.

### DETAILED DESCRIPTION OF INVENTION

The following is a listing of some of the components of the Video Frame Recorder (hereinafter “video frame”). Some of these components are contained within the video frame. Other components are external to the video frame and communicating through cords to ports on the back or sides of the video frame (hereinafter “peripheral”). This communication may be wireless. The peripheral components are external to or removable from the video frame, i.e., memory cards.

The video frame has at least one speaker; a port for a microphone which is a way to record audio into the video frame; components for optionally standing the video frame vertically or horizontally; a peripheral infra-red remote controller and signal receptor mounted within the frame; a Thin Film Transistor Liquid Crystal Display (hereinafter “TFT LCD”) touch screen display; a microprocessor; a video frame memory component; slot for sd/mmc card; at least one USB port; compact flash 11 micro-drive port; flash card ejector; and USB port 2.0, and an interface circuit. The micro-processor interfaces with the video frame memory component, an sd/mmc card and compact flash 11 micro-drive. Using the multi media card, images and text can be received from a remote source to the video frame. The infrared signal receptor also interfaces with the microprocessor. The video frame also includes a slot for LED lights on the video frame bottom when sitting horizontal or vertical; slot for wall-hanging of the video frame; space slots on the back where the remote control can be stored; telephone jack, USB ports, audio in-audio out jacks; video in-video out jacks; dimples for placement of the video frame in a vertical or horizontal position; 12V DC in port also contains a place for a battery pack (preferably Lithium ion) and an AC power cord.

The video frame may also be equipped with a key board (preferably “qwerty” configuration) connected to the video frame. The frame may also include a mouse plugged into the video frame. Both components interface with the microprocessor. Both components allow the user to control the operation of the video frame, including sound and picture editing. The video frame includes ports, preferably USB ports, to connect the mouse or keyboard.

The video frame may include an AC power supply. It may also include a connection port for a cell phone, thereby allowing photos and videos recorded with the cell phone camera to be down loaded to the video frame. The photos, videos and accompanying audio may be stored on the video frame memory or displayed on the video frame. The video frame may allow enhanced editing than possible with the phone software. This picture display is larger and can be magnified. The video speed can be slowed for more accurate edits. Audio music or narration can be added. The photos or videos may be displayed on the video frame or upon a television screen.

The video port may include a telephone jack that can connect a telephone to the video frame. The video phone may have a second jack connecting the phone line to a conventional telephone jack mounted in a wall. The microprocessor can allow the video frame to be used as a fax receiver. The facsimile text can be displayed on the TFT LCD touch screen or the text can be stored in the video frame memory. The video frame can include an MMS card, thereby allowing images or video clips to be inputted remotely and wirelessly. MMS cards are used in many cell phones and video and audio may be downloaded wirelessly to the video frame. The video frame microprocessor can be programmed play a predetermined video or still photo. It can also display a message on the video screen and play an audio message or music. In another embodiment, the calling phone number or caller identity can be displayed on the video screen.

The video screen may also be equipped with a camera mounted on the frame surrounding the LCD touch screen. The camera may be controlled by the mouse and key board or controlled by a Bluetooth system or by the infrared remote control. The prospective picture can be displayed to the photo subjects on the video frame. Therefore the subjects can correctly pose for the picture. The camera can be mounted at a corner of the frame so that the camera is placed high on the frame regardless whether the frame is mounted vertically or horizontally. In one embodiment, the direction of the camera lens can be rotated in orientation, e.g., upward, downward, etc.

The video frame may use an array of differing colored lights, e.g., blue/green/amber lights on bottom of the video frame and the light changes color as the battery loses power. The video frame also contains a switch to turn off/on the components of the video frame.

The video frame may also have a port to accept a plug from cell phones and cameras, and separate memory devices, including but not limited to personal computers and laptops, to transfer pictures and videos. Image and audio files can be uploaded from these external or peripheral devices to the video frame for display or for storage in the video frame memory component. Similarly, image and audio files, including video and photos, can be down loaded from the video frame to the peripheral (external) devices, e.g. cell phones, cameras, personal computers or laptops.

The video and audio inputs and output jacks of the video frame are to receive recorded signals from DVD's, VCR's, and mp3's. Any memory chip that is inserted into the video frame can also transfer to the memory component of the video frame (that preferably can hold ten gigs) and can also send video clips or still pictures made from the video clip back to the chip. The user can send to and from the video frame. The video frame will also have albums to where the user can store sections of friends' videos or pictures and other separate albums where the user can store family pictures or videos.

With the video frame the user can also erase selected parts of the video. The video frame will also play an entire video clip to pause at a selected frame and download the selected frame to a video frame. For example, the user can play and view a video and whenever the user sees the selected scene he or she can then pause the video, then download the video to the video frame memory. The user can then send back any of the clips that are being used and then can have the picture printed out on a machine that prints pictures. The video frame will also have a “zoom in” “zoom out” button so the user can zoom in or zoom out with, for example, 16 times magnification from a still picture or playing video. The video frame receives any video chip or picture chip with sound or movement. Any picture or video on the video frame can be rotated up to 360° degrees so when the user can rotate the camera to take a picture or video and can view it just like he or she wants. The video frame also can display a picture with or without sound. The video frame may also have a settings that show or control the properties of the video frame memory status, memory left, change the brightness, tone, contrast and other qualities of the image and sound as well as modify the date, time, alarm, settings, etc. This information internal to the video frame can be processed by the microprocessor. The information can be displayed on the touch screen.

The video frame also includes a clock, radio and alarm component. These components interface with the microprocessor. When the alarm goes off the video frame can display a picture with the sound of the recorded message that the owner has put in or other manner of sound such as the music that was able to be transferred to the picture or video on the frame. Alarm goes off and a video comes on and displays a recorded video. For example the video clip can be “mom” saying “Okay son, wake up, its time to go to school”. The video frame alarm had come on with sound of a mother from the speakers. Even though the mother was not there, the video frame said it all as if she was there. The alarm and display or audio can be programmed using the touch screen control display.

The video frame can be programmed to provide a slide presentation of photos and video clips. The user can personalize the way he views an array or group of images. He can choose to have them displayed at random or in a selected order. Videos or pictures can work in this slide transition. An audio narration can be created by the user that is played simultaneously and synchronized with the slide display. He can also choose a particular “frame” from a list of options so that the video frame has a new visual identity each time he uses it.

Volume controls—the user can set the volume of the video that is being played or the music that the picture frame plays in the background of the images. By talking into the microphone of the video frame the user can record a background narration under the sound the video clip or photo already has recorded or record the narration over the sound that the video or picture already has. There may be three ways to record on a still frame or video clip; low, medium or high. The low is the background, the medium is normal level and the high is over the sound already used. The video frame will have control buttons that are displayed on the touch screen or remote control such as next/previous buttons and scroll onto albums. These buttons will help the user to go through the slide show by fast forwarding it. When in video mode the button helps fast forward and rewind the video clips. The longer the user presses the zoom button the faster the image may move from normal to maximum magnification, e.g., 16× magnification. The video frame can also be used as a daily diary, which everyone wants to keep. The video frame will also take a small picture, like from a phone and view it onto a big screen TV. This means the user can use this one size video frame and view images into any size TV to see the big picture right away. The user would not have to buy other sizes of a video frame.

The video frame uses all clips that are used in cell phones, cameras, video cameras and other items as well as from a computer. The video frame can store information, pictures, video clips, music-mp3.

The invention comprises a video frame. The video frame is connected to at least one speaker. Preferably the speakers are built into the video frame. The speakers can also be external to the video frame. The video frame may include slots to distribute the sound from the speakers into the room. Built into the video frame are also a sound player and recorder. The video frame can have a port for receiving a signal from a microphone. The video frame can also be enabled with Bluetooth technology permitting signals to be delivered wirelessly to the video frame. Bluetooth includes a wireless protocol for exchanging data over a short distance from fixed and mobile devices creating personal area networks. The video frame also includes an input port for audio. The video frame also includes audio output. The microphone, Blue Tooth (hereinafter termed “short distance wireless protocol”), and audio input may interface through the microprocessor with the memory component of the video frame.

The video frame also includes a touch controlled LCD screen. The touch component may be one of multiple technologies such a resistive touch screen panel, surface acoustic wave technology, capacitive and projected capacitance. A still image or video display may be positioned within the decorative frame component to provide the illusion of a picture within a traditional frame.

The video frame can be positioned horizontally, i.e., having a broad base relative to the video frame height. Alternatively, the video frame can be positioned vertically, i.e., having a narrow base relative to the video frame height. The video frame can be square and rotated 90° for mounting.

Included is also an infra-red controller to control the functions of video frame components (described below). The infra-red signal receiver receives signals from a remote control device. The signal receiver may be located on the front of the video frame.

A principal component of the video frame is the thin film transistor, a type of a liquid crystal display “LCD” flat-panel display screen in which each pixel may be controlled by one to four transistors. This screen is hereinafter referred to “TFT-LCD touch screen display”. The TFT glass has as many thin film transistors as the number pixels displayed. Preferably the TFT-LCD screen utilizes active-matrix driving or active addressing. In active-matrix LCDs, a switching device and a storage capacitor are integrated at each cross point of the electrodes. The active addressing removes the multiplexing limitation by incorporating an active switching element. Active matrix LCDs have no inherent limitation in the number of scan lines, and they present fewer cross-talk issues. The touch screen feature can be achieved through the various technologies available. These include but are not limited to resistive, surface acoustic wave, capacitive, projected capacitance or strain gauge.

In addition to the TFT-LCD touch screen display and the audio player and recorder and the microprocessor, the video frame includes other components including a memory chip. Preferably the chip will have 10 gigabytes (10×1024³ bytes) of memory. The memory may be on a printed circuit board (sometimes designated “PCB”). The video frame may include components to record images from a digital camera and display data from the memory chip or card, for example the sd/mmc card. The data can be displayed on the TFT-LCD touch screen display (hereinafter “touch screen”).

The video frame may also include an infra-red remote receiver in communication with the memory chip or card, video and audio input and output, USB, the TFT-LCD touch screen display, audio player, and video player.

For example, the touch screen can display instructions or icons that allow the user to control the actions of the video frame by touching the appropriate instruction or icon. In one embodiment, an initial touching may “freeze” the frame in a video clip. Alternatively, the screen may display topical lists such as “picture”, “sound”, “date/calendar”, “memory” or “settings”. The touch screen may contain a paused video image. The instructions or listings are displayed over the paused image. If “settings” is selected, a submenu may appear including “play a sound”, “record a voice over”, “edit background sound” or “mute”. The user can press the instruction for “record a voice over”. The user's speech is saved on the video frame memory in conjunction with video (also stored on memory). In another example, the screen icons can list “set clock”, “set alarm”, “select alarm program”. The alarm program may include a video clip or still photo.

Other components may include a microphone port, infra-red remote receiver, an SDIO slot for an SD or MMC card or similar card, a compatible card reader, at least one USB port, compact flash II microdrive port (USB 2.0 port); flash card ejector; slot or other mounting fixture for LED lights proximate to the frame surrounding the TFT-LCD video screen; slot for wall-hanging of the video frame, space slots on the back where the remote can be stored; audio in/audio out ports; adaptations to the video frame for placement of the video frame in a vertical or horizontal position; and a 12V DC port connection and battery pack holder. Preferably lithium ion batteries will be utilized.

In regard to the LED lights which may be optionally emitted from the bottom of the frame surrounding the TFT-LCD video screen, the frame may use an array of different colored lights, e.g., blue/green/amber lights. There may be two sets of LEDs, one for each video frame side that may be the video frame bottom. The light color may change from blue to green and then amber as the battery loses power. It will be appreciated that other colors may be used and are within the scope of this invention.

The video frame may contain video and audio input and output jacks adaptable to DVD and VCR players and to mp3 players. A digitizer may be included within the video frame to convert an analog tape signal to a digitally displayed image. This allows video clips with audio to be played or displayed on the video frame as well as downloaded onto the memory of the video frame. Further, video clips can be transferred from the memory of the video frame to another memory device, e.g. a multimedia card (mmc) (a flash memory card) or a secure digital card (sd). The video and audio input and output jacks can be used to connect video and audio cable to the video frame and a television or other monitor to display the visual image and audio stored on the video frame memory.

The video frame can display a listing of files. Each video or audio input may retain the identifier assigned by the camera, scanner or audio source. The user may assign new identifiers.

The video frame memory will be divisible into files. The files can serve as albums containing videos and photos of family and friends. These files can be stored on the video frame memory. In another embodiment, the user may download images or sounds to designated files.

The controls and components incorporated into the video frame allow the user to erase sections of a video clip, e.g., a section of a video clip that is blurred. This may utilize a “delete” or “erase” control key. The controls and components allow the user to pause a video clip at a selected frame. This paused video segment can be downloaded as a still photo into the memory of the video frame. The still photo made from the video can used to make a physical photograph.

The remote control device will also have a “zoom in” “zoom out” button so you can zoom in zoom out up in magnification such as to 16 times magnification from a photograph (still photo) or video. This magnification capability also extends to a display of video or photograph presentation on a connected television. The whole video frame receives any video chip or picture chip with sound or movement.

Any picture or video on the video frame can be rotated up to 360° degrees using the controls on the remote so when the user rotates a picture on the camera the user can view it just like he wants.

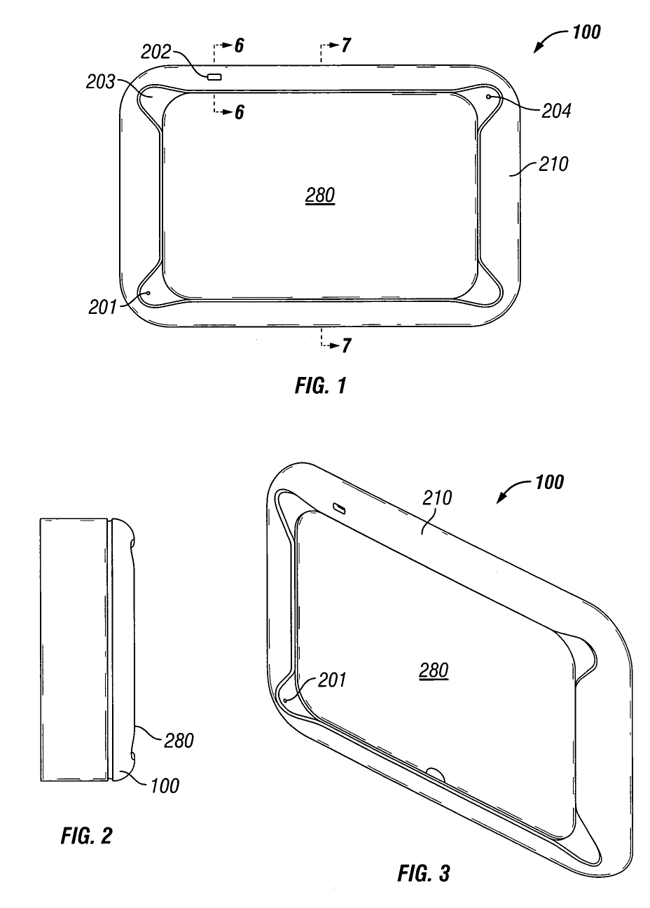

Turning now to the illustrations, FIG. 1 illustrates one embodiment of the device 100. Illustrated is a microphone input port 201. The four sided frame 210 is illustrated and framing the TFT-LCD touch screen 280. An optional indentation 203 for each frame corner is illustrated. This provides a location for connections or other devices on the face of the video frame. A camera 204 may be contained in the frame within such indentation. It is positioned to occupy a high position on the frame regardless whether the frame is in a vertical or horizontal position. An infra-red signal receiving port 202 is also illustrated.

FIG. 2 is a side view of the video frame 100 and the TFT LCD touch screen. FIG. 3 is a perspective view of the video frame 100 illustrating the TFT LCD touch screen 280, the microphone port 201 and the decorative frame 210.

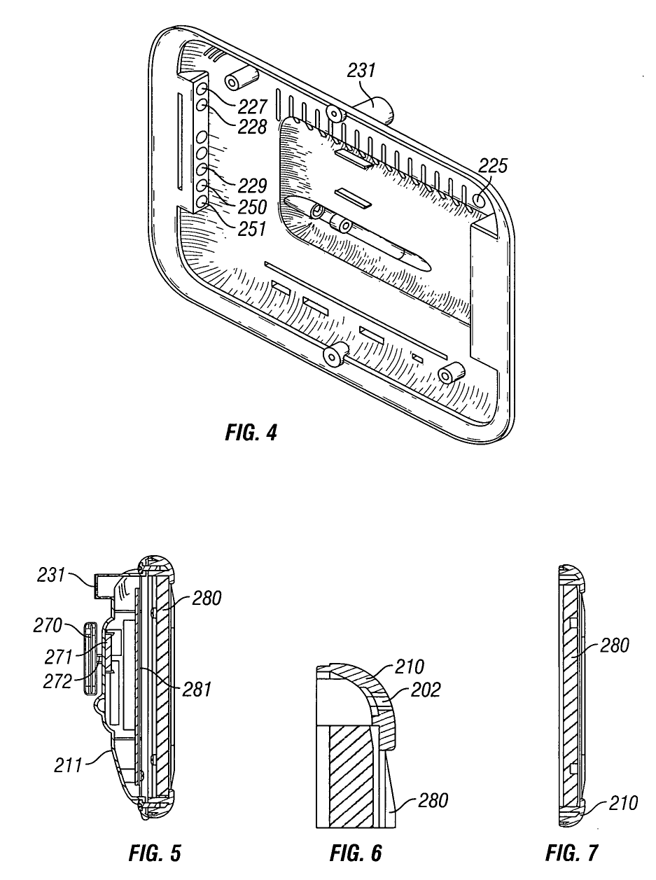

FIG. 4 illustrates an interior view of the back cover panel forming part of the video frame. Illustrated are an audio input port 227, audio output port 228, video in port 229, video out port 250 and a Universal Serial Bus (USB) 251. Also illustrated are key board port 223, mouse port 224, printer port 222, cell phone (USB port) 221. It will be appreciated each may be a USB port. Additional USB ports may be added to the video frame.

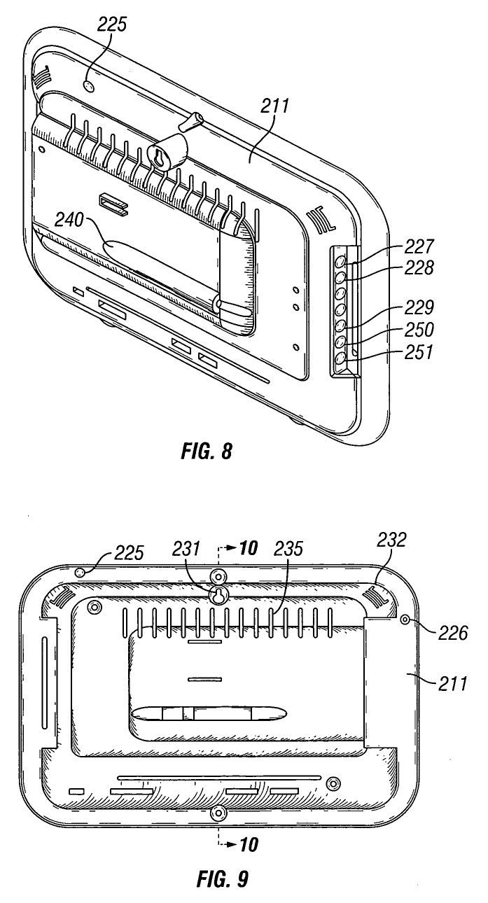

FIGS. 8 and 9 illustrates an exterior view of the back cover 211 of the video frame. Illustrated are the slotted speaker covers 232 and wall mounting attachment 231 for the horizontal position. Also illustrated are an audio input port 227, audio output port 228, video in port 229, video out port 250 and a USB port 251. Also illustrated are heat ventilation slots 235.

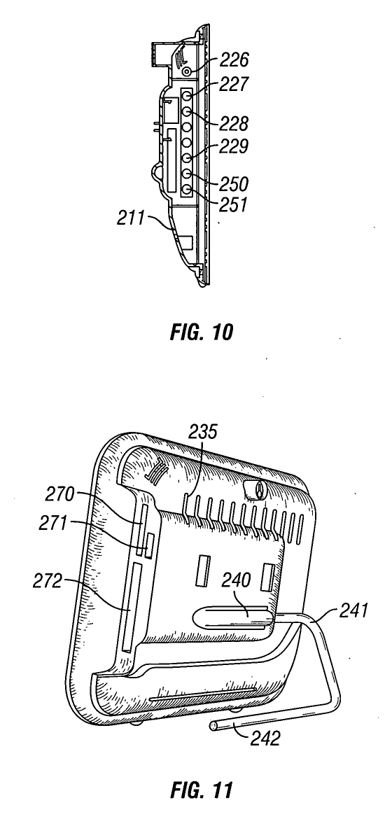

FIG. 10 is a cross sectional view of the video frame showing the back 211, an audio input port 227, audio output port 228, video in port 229, video out port 250 and a USB 251. FIG. 11 illustrates another embodiment wherein the video frame utilizes a bracket 241. One end of the bracket fits into a bracket holder 240 at the back of the video frame 211 and the other end 242 forms a stand holding the video frame upright on a flat surfaces, e.g., a desk or table. Also illustrated in FIG. 11 are the slots for the sd/mmc card 270 or similar card, at least one USB port 271, and a compact flash 11 microdrive port 272 (which may be a USB 2.0 port)

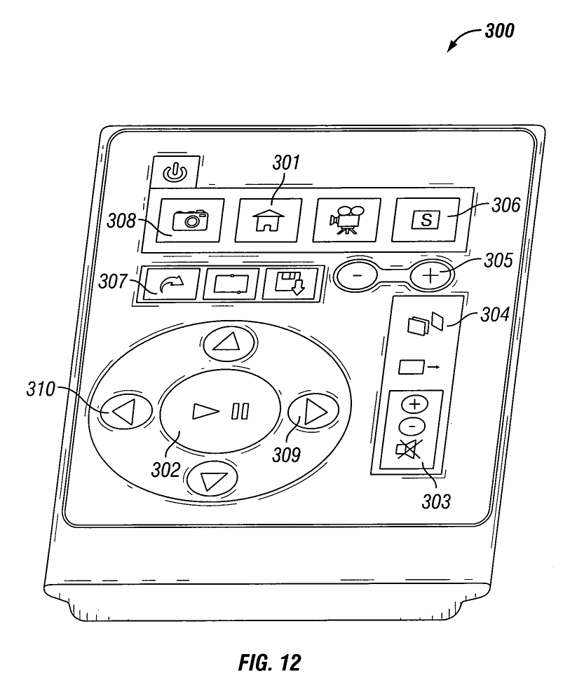

FIG. 12 illustrates one embodiment of the infrared remote control component 300. In the embodiment illustrated, the control contains a Home Menu 301 button that activates the touch screen menu. Also available is a Mode Select button 308 that allows the user to toggle/jump between the images and video mode. The three Picture Action buttons 307 enable the user to rotate, save a picture and also to view a set of pictures in a continuously repeating loop. The Central Pause/Play button 302 allows the user to take a still shot of a video and store it in the internal memory of the video picture frame. The two Next/Previous buttons 309, 310 control the sequence of presentation. The control also contains three Volume Control buttons 303, include a mute button. The user can set the volume of the video that is being played or the music that the picture frame plays in the background of the images. The Zoom Control 305 allows the user to zoom in and zoom out of a still image. The Settings button 306 shows the properties of the video frame, including quantity of memory used, and memory left. The user can go into this Settings menu and change the brightness, tone, contrast and other qualities of the image or sound as well as modify the date, time, alarm settings, etc.

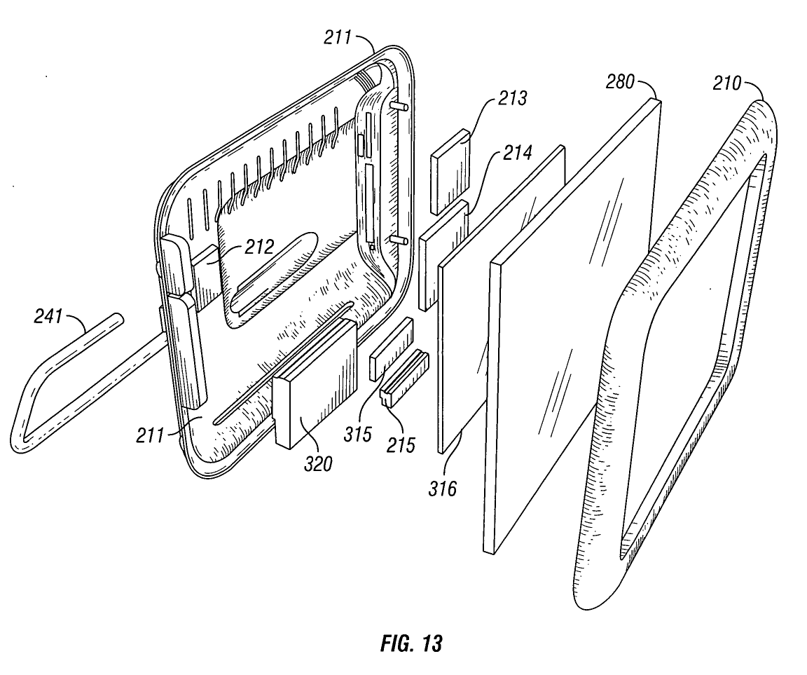

FIG. 13 is an exploded perspective view of the video frame, the TFT LCD touch screen 280, the memory unit (preferably 10 GB PCB with built in flash memory 316), microprocessor 315, battery pack (preferably Lithium ion) 320, audio-pack ports 212 (input and output), the video frame back cover 211, back stand 241, sd/mmc card reader 213, CF II microdrive (hard disk) reader 214 or compact flash (CF) II slot LED array 215.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

What we claim is:

1. A video frame comprising a touch screen that can display instructions or icons that control the action of the video frame by touching the appropriate instruction or icon.

2. The video frame of claim 1 further comprising a keyboard display on the touch screen wherein touching the keyboard can control functions of the video frame.

3. The video frame of claim 1 further comprising a port connectable to a camera for the transfer of video, photo or audio signals.

4. The video frame of claim 1 further comprising a component capable of receiving short distance wireless protocol signals, converting the signals and communicating the converted signals to a microprocessor of the video frame.

5. The video frame of claim 1 further comprising ports connectable to a mouse or keyboard.

6. The video frame of claim 1 further comprising a display of video clips or photos.

7. The video frame of claim 6 further comprising music or narration.

8. The video frame of claim 1 further comprising at least one telephone jack wherein telephonically transmitted data can be communicated to the video frame.

9. The video frame of claim 8 wherein the telephonically transmitted data comprises facsimile transmission.

10. The video frame of claim 1 that can download video, photo and audio signals to peripheral or external memory devices.

11. A video frame comprising:
a) touch screen;
b) a camera control component; and
c) a camera that can display the camera image in the touch screen.

12. The video frame of claim 10 wherein the camera control equipment is a infrared signal generator and infrared signal receiver.

13. The video frame of claim 10 further comprising short distance wireless protocol signal transmitter and receiver.

14. The video frame of claim 10 further comprising positioning the camera in a corner of the frame.

15. A video frame of claim 1 that can upload video, photo and audio signals from peripheral or external memory devices.

16. A video frame comprising:
a) a frame;
b) a TFT LCD touch screen;
c) an inferred signal detector;
d) at least one speaker;
e) a camera;
f) a microprocessor;
g) an interface circuit;
h) a memory component;
i) a clock;
j) an alarm switch activated by the clock; and
k) programmed audio and visual for display and play upon activation of the alarm.

17. The video frame of claim 16 further comprising:
a) an image magnifier;
b) a video pause control; and
c) a delete control.

18. The video frame of claim 16 further comprising:
a) lights on the frame; and
b) controllers synchronizing the lights with audio signal.

19. A method of displaying images comprising imputing the images into a video screen memory, imputing audio into the video screen memory, selecting the images to be displayed, and selecting the audio to be played simultaneous to the image display.

20. The method of claim 16 further comprising imputing the video and audio using a control display presented on a touch screen.
